(19) United States
(12) Patent Application Publication
(10) Pub. No.: US 2026/0219029 A1
(43) Pub. Date: Jul. 30, 2026

(54) MODULAR SYSTEM FOR TEACHING INTERFEROMETRY

(71) Applicants: Jose Gabriel Ortega Mendoza, Hidalgo (MX); Jose Armando Escamilla Angelez, Hidalgo (MX); Arturo Barraza, Hildago (MX)

(72) Inventors: Jose Gabriel Ortega Mendoza, Hidalgo (MX); Jose Armando Escamilla Angelez, Hidalgo (MX); Arturo Barraza, Hildago (MX)

(21) Appl. No.: 19/150,839

(22) PCT Filed: Jun. 20, 2023
(86) PCT No.: PCT/MX2023/050037

§ 371 Date: Jul. 24, 2025

(30) Foreign Application Priority Data
Jan. 24, 2023 (MX) MX/A/2023/001076

(51) Int. Cl. G01B 9/02

(52) U.S. Cl. CPC G01B 9/02049

(57) ABSTRACT

A modular device for the teaching of interferometry, from which either a Michelson-type or a Mach-Zehnder-type interferometer can be assembled. The system's optical components are mounted on the faces of a rectangular prismatic structure. Each of the panels that form the prism includes rectangular edge cutouts, allowing the panels to interlock using finger or comb-type joints. This design makes the assembly of the interferometer intuitive and quick, as well as the alignment of the system to observe the interference pattern. Furthermore, it is possible to increase the size of the interferogram by increasing the distance between the interferometer and the observation screen. This is achieved through the use of a divergent laser light source. The instrument is highly useful in educational settings due to its ease of assembly—whether for a Michelson or a Mach-Zehnder interferometer—and its simple alignment.

### TECHNICAL FIELD

The present invention relates to the field of physical optics. More specifically, it pertains to the area of teaching the phenomenon of electromagnetic wave superposition through modular interferometry equipment designed to assemble or construct a Michelson or Mach-Zehnder type interferometer, whose optical elements are positioned on the faces of a rectangular prismatic structure that can be assembled and disassembled, using a divergent laser light source.

### BACKGROUND

Interferometers are optical instruments used in various fields, such as industry, medicine, research, education, among others. Their main applications lie in the measurement of physical quantities, image reconstruction, and analysis of biological systems, to name a few. These instruments are composed of optical elements arranged in specific positions that depend on the configuration used. The most widely used interferometer configurations worldwide are Michelson and Mach-Zehnder (FIGS. 1A-1B). Both configurations are capable of generating, through the superposition of light waves, interference patterns generally composed of alternating bright and dark fringes. This resulting intensity distribution is known as an interferogram or interference pattern. However, obtaining an interferogram requires theoretical and practical knowledge, which tends to be complex for non-specialist users.

Various interferometers capable of generating the phenomenon of optical interference are known in the state of the art. The Michelson interferometer is composed of an extended coherent light source, a beam splitter, and two mirrors, as shown in FIG. 1A. The light beam emitted by the source travels toward the optical splitter, which is responsible for dividing the beam into two beams. Both beams are directed toward mirrors M1 and M2, where they are reflected back to the beam splitter, where they are recombined and subsequently continue their path to the screen, where the interference pattern formed by dark and bright fringe is visualized. When the light source is a laser (Twyman-Green interferometer), an additional optical system is required in order to expand and collimate the beam (not shown in the figure).

The Mach-Zehnder interferometer, like the Michelson interferometer, belongs to the family of amplitude-splitting interferometers, in which the light beam from a single source is divided into two parts by a beam splitter. These partial beams then travel along different paths, are deflected by mirrors, and are recombined by another beam splitter, where they interfere with each other. Due to the interference of the light waves, an interference pattern is produced. Unlike the Michelson interferometer, the light beams in the Mach-Zehnder configuration are not reflected back upon themselves after being split but instead travel along independent paths until they are recombined. The adjustment of a Mach-Zehnder interferometer is usually more complex than that of a Michelson interferometer; therefore, it is advisable to gain experience with the Michelson type before assembling a Mach-Zehnder interferometer.

Typically, Michelson or Mach-Zehnder interferometers are assembled on a metal plate (optical bench), on which each of the optical components is placed. The alignment of the system to observe the interference fringes on the screen is very difficult for individuals with little or no knowledge of the subject.

However, with this modular equipment, alignment becomes so simple that individuals with no prior experience in interferometer implementation can easily and quickly obtain an interference pattern.

Nevertheless, a well-known drawback for technicians in the field is that, to visualize an interferogram using a Michelson or Mach-Zehnder type interferometer, it is essential that the two output beams are parallel and at the same height. For this, the following considerations must be taken into account:

I. The height of the light source is the initial parameter for proper visualization of the interferogram since it must be maintained throughout the light beam's path. This implies that all optical elements used in the interferometer must be placed at the same height.

II. The beam splitter must be placed at a 45° angle with respect to the beam propagation axis and completely perpendicular to the working surface.

III. The mirrors used must be initially positioned perpendicular to the beam's propagation path in the case of the Michelson interferometer, or at 45° for the Mach-Zehnder implementation. For these reasons, mirrors are mounted on special bases that allow the redirected light beam to be properly aligned.

IV. Finally, the two light beams redirected by the mirrors-both of which must be parallel-must recombine and overlap at the interferometer's output in order to form the interferogram.

Experimentally, controlling all the parameters mentioned above is complex, since minimal variations in the positions of the optical elements can prevent the visualization of the interferogram.

### OBJECT OF THE INVENTION

Based on the above, the proposal described in this specification is based on a prismatic structure, preferably rectangular, which includes slots in the appropriate positions and inclinations for mounting the optical elements, as well as for installing mirror tilt mechanisms. This structure ensures that all optical elements are located at the same height, that the beam splitters are positioned at the correct angle, and that there is also an output aperture to ensure that the two output beams are parallel. All of this allows for fast and easy alignment for observing the interferogram, even when operated by individuals with limited knowledge of optics.

The modular equipment for teaching interferometry, from which a Michelson-type or Mach-Zehnder-type interferometer can be assembled, is specially designed so that the system's optical components are mounted on the faces of a rectangular prismatic structure. Each of the panels that make up the prism contains, along its perimeter, rectangular cutouts so that these panels can be joined together using interlocking joints known as finger joints or comb joints. This results in intuitive and fast assembly of the interferometer, as well as easy alignment of the system to observe the interference pattern. Furthermore, the size of the interferogram can be increased by increasing the distance between the observation screen and the interferometer. This is possible because a divergent laser light source is used. This instrument is highly useful in the educational field due to the ease of assembling either a Michelson-type or Mach-Zehnder-type interferometer, as well as for its simple alignment.

Therefore, the present invention is aimed at overcoming the known disadvantages in the state of the art. To this end, the optical components forming part of the equipment are specially designed to be mounted on the faces of a rectangular prism. This allows for fast and simple alignment, even by individuals with little or no experience in the field of interferometry. Additionally, a coherent and divergent light source is used, which allows the observed interferogram on the screen to be enlarged by increasing the distance between the screen and the interferometer.

In this regard, a main object of protection relates to modular equipment for the teaching of interferometry, characterized in that it comprises a plurality of panels assemblable with one another to form a main structure, which is composed of a base panel (5) that includes four holes (7) located at each corner of the main structure, and in its central part it includes a central slot (9) in a diagonal arrangement, and two longitudinal slots (23), with the central slot (9) located between the two longitudinal slots (23) for placing at least one beam splitter (8);
the first rectangular perimeter panel (1) includes a plurality of central slots (20) and a connection hole (17) adjacent to the central slots (20), and lateral assembly slots (22), arranged near one of its lateral edges, and another connection hole (17) adjacent to the assembly slots (22); said central slots (20) and said assembly slots (22) serve to couple amount in the required position, whether in the central part or the lateral part of the first panel (1), where the mount includes a hole to place a light-emitting source directed toward the beam splitter;
a second rectangular perimeter panel (2) with a plurality of fastening holes (11); said second rectangular perimeter panel (2) includes an elliptical cutout (10) in the central part of its lateral edge that is adjacent to a third rectangular perimeter panel (3); the third rectangular perimeter panel (3) includes a plurality of fastening holes (11);
said third rectangular perimeter panel (3) includes an elliptical cutout (10) in the central part of each of its lateral edges for the output of the interference pattern;
a fourth perimeter panel (4) with a central hole (28) for the output of the interference pattern and a plurality of fastening holes (11); said fourth perimeter panel (4) includes an elliptical cutout (10) in the central part of its lateral edge that is adjacent to the third rectangular perimeter panel (3); and
a rectangular upper panel (6), which defines the top cover of the main structure once the interferometer is assembled;
wherein the fastening holes (11) of the perimeter panels are arranged longitudinally and evenly spaced, with at least one located above the lateral edges, which house tilt adjustment mechanisms of a light-reflecting medium, preferably a mirror (16).

### BRIEF DESCRIPTION OF THE FIGURES

The modular equipment of the present invention is illustrated in the attached figures, which in seven views provide a clear and complete idea of its shape and configuration.

FIGS. 1a-1b. Show in 1a) the basic experimental setup of the Michelson interferometer, and in diagram 1b) the basic experimental setup of the Mach-Zehnder interferometer.

FIG. 2. Shows the top view of the panels of the equipment that form the rectangular prismatic structure, where a single structure is used to assemble either Michelson-type or Mach-Zehnder-type interferometers. Rectangular cutouts can be seen along the perimeter of each of its faces, allowing the panels to be joined using finger or comb-type joints.

FIG. 3. Shows a projected view of the final assembly of all the parts of the equipment, defining the final structure of the third modality of the equipment for assembling a Michelson-type interferometer using the rectangular pieces, which are joined by finger or comb-type joints.

FIG. 4. Shows a projected view of the final assembly of all the parts of the equipment, defining the final structure of the third modality of the equipment for assembling a Mach-Zehnder-type interferometer using the rectangular pieces, which are joined by finger or comb-type joints.

FIG. 5. Shows the top view of the panels of the equipment that form the Michelson-type interferometer, where the rectangular cutouts can be seen along the perimeter of each of its faces, intended for joining via finger or comb-type joints.

FIG. 6. Shows the frame where the beam splitter is placed, which is another component of the equipment.

FIG. 7. Shows the representation of the final structure for the mirror mounting and the tilt mechanism of the mirror holder, which form part of the equipment.

FIG. 8. Shows the components for the laser diode mount, using the same finger-type assembly system.

FIG. 9. Shows a projected view of the final assembly of all the parts of the equipment, defining the final structure of the second modality of the Michelson-type interferometer using the rectangular pieces, which are joined by finger or comb-type joints.

FIG. 10. Shows the top view of the panels of the equipment that form the rectangular prismatic structure in its second modality, for Mach-Zehnder-type interferometers. Rectangular cutouts can be seen along the perimeter of each of its faces, intended for joining via finger or comb-type joints.

FIG. 11. Shows the representation of the final structure for the mirror mounting and the tilt mechanism of the mirror holder, which form part of the second modality of the equipment.

FIG. 12. Shows the components for the laser diode mount, in its second modality, using the same finger-type assembly system.

FIG. 13. Shows a projected view of the final assembly of all the parts of the equipment, defining the final structure of the second modality of the equipment for assembling a Mach-Zehnder-type interferometer using the rectangular pieces, which are joined by finger or comb-type joints.

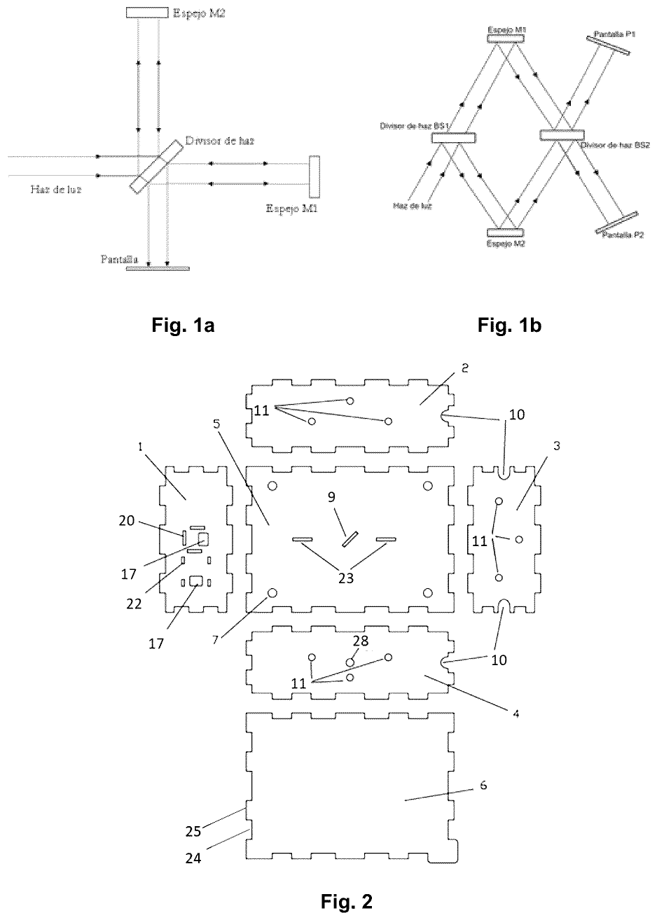

### DESCRIPTION OF THE INVENTION

The modular interferometry equipment for teaching proposed by the invention, and which is specifically designed for a Michelson-type or Mach-Zehnder-type interferometer configuration, consists of a plurality of panels, specifically six interconnectable panels: one base, four perimeter panels, and one top panel, such that when assembled they form a main structure in the shape of a rectangular prism; a mount for a laser diode; a laser diode to be coupled to the mount; at least one beam splitter, which consists of a partially reflective mirror mounted on a rectangular frame; two mirrors with mirror holders; and tilt adjustment mechanisms where the mirrors are mounted. These tilt adjustment mechanisms, when assembling the interferometer, are attached to two of the perimeter walls of the main structure. These mechanisms consist of three butterfly nuts (12), which are screwed in using bolts (13), and three springs (14), which, when the interferometer is assembled, are arranged on the inner face of the wall of the prismatic structure. A rectangular mirror holder (15) clamps the springs against the inner wall of the face of the prismatic body, and the mirror holder (15) includes a mirror (16) on its inner face, which coincides with the interior of the prismatic body as a whole.

In a preferred aspect of the invention, with reference to FIG. 2, the modular equipment for teaching interferometry includes a rectangular base panel (5) with four holes (7) located at each corner of the base (5) of the main structure, and in its central part it includes a diagonal central slot (9) and two longitudinal slots (23), with the central slot (9) positioned between the two longitudinal slots (23).

A first rectangular perimeter panel (1), which includes central slots (20) and a connection hole (17) adjacent to the central slots (20), and lateral assembly slots (22), located near one of its lateral edges, and another connection hole (17) adjacent to the assembly slots (22), for inserting the connection to the light emission source. These central slots (20) and lateral assembly slots (22) serve the function of coupling amount in the required position, either in the central part or in the lateral part of the first panel (1).

A second rectangular perimeter panel (2) with fastening holes (11), consisting of 3 fastening holes (11) preferably arranged in the configuration of three vertices of an imaginary triangle; said second perimeter panel (2) includes an elliptical cutout (10) in the central part of its lateral edge, which lies adjacent to a third rectangular perimeter panel (3).

A third rectangular perimeter panel (3) with fastening holes (11), consisting of 3 fastening holes (11) preferably arranged in the configuration of three vertices of an imaginary triangle; said third rectangular perimeter panel (3) includes an elliptical cutout (10) in the central part of each of its lateral edges.

And a fourth perimeter panel (4) with a central hole (26) and fastening holes (11), consisting of 3 fastening holes (11) preferably arranged in the configuration of three vertices of an imaginary triangle; said fourth perimeter panel (4) includes an elliptical cutout (10) in the central part of its lateral edge, which lies adjacent to the third rectangular perimeter panel (3).

Wherein the first and third perimeter panels (1 and 3) are shorter in length than the second and fourth perimeter panels (2 and 4).

A rectangular top panel (6), which defines the top cover of the main structure once the desired interferometer is assembled.

All of these panels (1, 2, 3, 4, 5, and 6) include along their perimeter edge assembly cutouts, defining a plurality of rectangular notches (24) and rectangular tabs (25), arranged alternately for interlocking assembly, such that the tabs of one panel are inserted into the notches of an adjacent panel to form a prismatic main structure.

The modular interferometry equipment includes at least one beam splitter (8), which consists of a partially reflective mirror mounted on a rectangular frame, preferably two beam splitters (8), since the Michelson-type interferometer uses one beam splitter (8) and the Mach-Zehnder-type interferometer uses two beam splitters (8), and in this third modality the modular equipment is designed to allow either of these two types of interferometers to be assembled using the same prismatic structure built from the perimeter panels (1, 2, 3, and 4), the base (5), and the top panel (6).

The modular interferometry equipment includes a divergent laser light emission source, which consists of a laser light diode, and mirrors (16), which are respectively mounted on mirror holders and in turn are coupled to tilt adjustment mechanisms.

The modular interferometry equipment includes a pair of tilt adjustment mechanisms, each consisting of three butterfly nuts (12), which, when assembling the interferometer, are positioned on the external part of the prismatic main structure. These are screwed in using bolts (13) whose heads are located inside the prismatic structure and clamp (together with the butterfly nut) one of the perimeter panels of the prismatic main structure; three helical springs (14), which, when assembling the interferometer, are clamped between one of the perimeter panels of the prismatic main structure and a rectangular mirror holder (15), with said springs (14) being traversed longitudinally by the bolts (13); and where the mirror holder (15) includes a mirror (16).

Thus, if a Michelson-type interferometer is to be assembled, the adjustment mechanisms are mounted on two adjacent perimeter walls, and in the case of a Mach-Zehnder-type interferometer, the adjustment mechanisms are mounted on two opposite perimeter walls.

The light emission source consists of a laser light diode powered by a 5-volt supply through a micro USB module aligned with one of the connection holes (17) of the first perimeter panel (1), for its power supply, where the diode is inserted into a mount, which is composed of a plurality of plates.

The modular interferometry equipment includes at least one mount to be attached to the first perimeter panel (1), which preferably includes a first mount that can be assembled in the form of a quadrangular prism, comprising five square plates (18, 19) interconnectable with each other—four perimeter plates (18) and one front plate (19)—with their respective rectangular cutouts along the perimeter, where these form an interlocking arrangement for assembling the mount.

And a second mount that can be assembled in the form of a triangular prism, comprising a square plate (19), a base plate, and a triangular top plate (18), as well as a diagonal plate (26) with a central hole (21); all of these plates (18, 19, and 26) are coupled together by means of their respective rectangular cutouts along the perimeter, forming an interlocking arrangement for assembling the second mount.

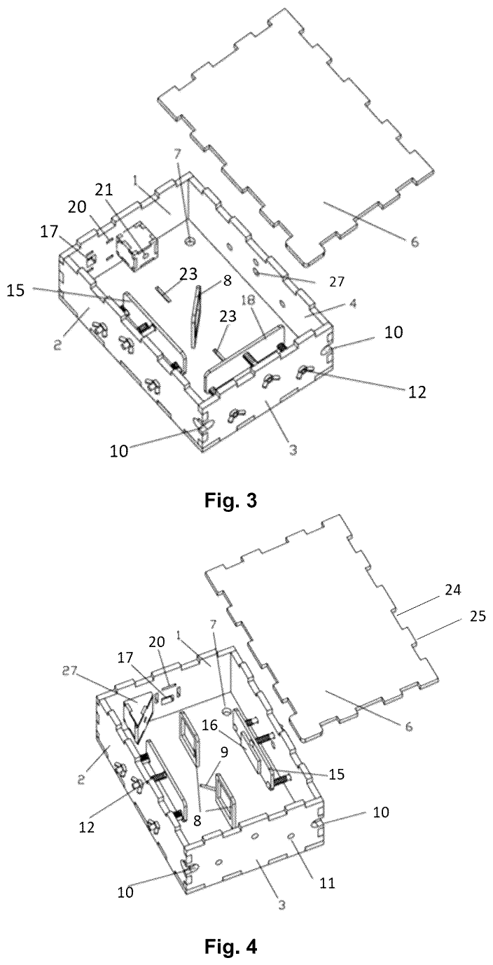

It should be noted that, if a Michelson-type interferometer is to be assembled (FIG. 3), the first quadrangular prism-shaped mount is coupled to the central slots (20) of the first perimeter panel (1) of the prismatic main structure, while the diode is inserted into a hole (21) located in the center of the front plate (19) of the first mount; and in the case of assembling a Mach-Zehnder-type interferometer (FIG. 4), the second triangular prism-shaped mount is coupled to the slots (22) of the first perimeter panel (1) of the prismatic main structure when assembling the interferometer, while the diode is inserted into a hole (21) located in the center of the diagonal plate (26) of the mount.

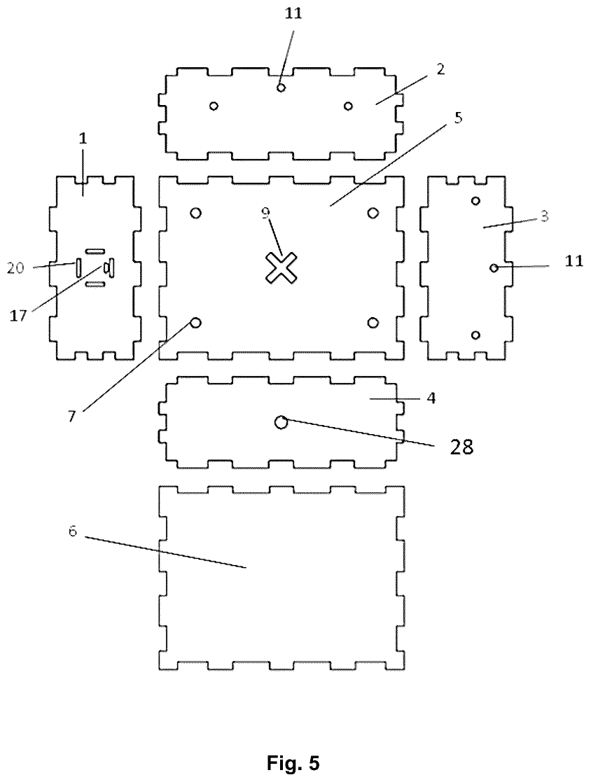

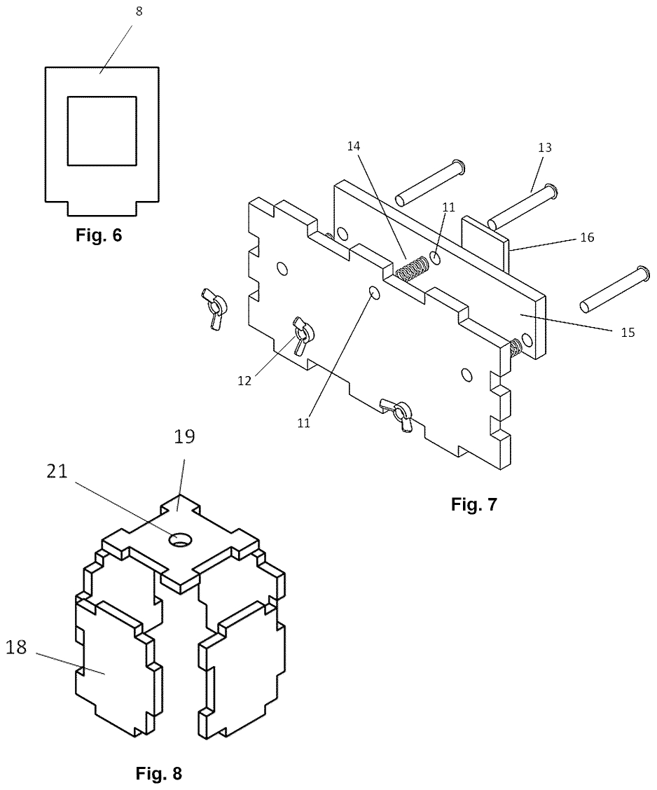

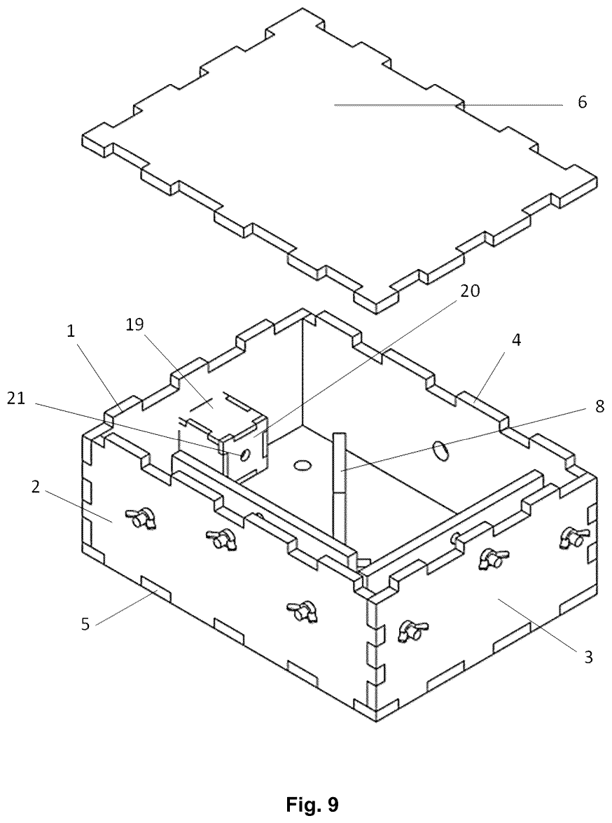

In a first considered modality, the modular interferometry equipment for teaching is designed to assemble a Michelson-type interferometer, whose optical elements are mounted on the faces that make up a rectangular prismatic structure. With reference to FIG. 5, according to this first modality, the panel (5) that defines the rectangular base (5) of the main structure includes four holes (7) located at each corner of the base (5) of the main structure, and in its central part a central slot (9) defined by a cross-shaped cavity.

A first rectangular perimeter panel (1) with central slots (20) to couple amount, and a connection hole (17) adjacent to the central slots (20) to insert the connection to the light emission source; a second rectangular perimeter panel (2) with fastening holes (11), which will receive the bolts (13) of one of the tilt adjustment mechanisms; a third rectangular perimeter panel (3) with fastening holes (11), which will receive the bolts (13) of the other tilt adjustment mechanism; and a fourth perimeter panel (4) with a central hole (28) for output of the interference pattern.

Wherein the first and third perimeter panels (1 and 3) are shorter in length than the second and fourth perimeter panels (2 and 4).

A rectangular top panel (6), which defines the upper cover of the main structure once the interferometer is assembled.

All of these panels have assembly cutouts along their perimeter edges, defining a plurality of rectangular notches (24) and rectangular tabs (25), arranged alternately for interlocking assembly, with the tabs of one panel being inserted into the notches of an adjacent panel to form a prismatic main structure.

The beam splitter (8) consists of a partially reflective mirror mounted on a rectangular frame; a divergent laser light source, which consists of a laser light diode.

The mirrors (16) are respectively mounted on mirror holders and are in turn coupled with the tilt adjustment mechanisms.

The tilt adjustment mechanisms consist of three butterfly nuts (12), which, when assembling the interferometer, are arranged on the outer part of the prismatic main structure, where they are screwed in using bolts (13) whose heads are located inside the prismatic structure and clamp (together with the butterfly nut) one of the perimeter panels of the prismatic main structure; three helical springs (14), which, when assembling the interferometer, are clamped between one of the perimeter panels (2 and 3) of the prismatic main structure and a rectangular mirror holder (15), said springs (14) being traversed longitudinally by the bolts (13), and where the mirror holder (15) includes a mirror (16).

The light emission source consists of a laser light diode powered by a 5-volt supply through a micro-USB module aligned with the connection hole (17) of the first perimeter panel (1), for its power supply. The diode is inserted into a mount composed of five square plates (18, 19) interconnectable with each other—four perimeter plates (18) and one front plate (19)—with their respective rectangular cutouts along the perimeter, forming an interlocking arrangement for assembling the mount, wherein it should be noted that these perimeter plates (18) are coupled into the slots (20) of the first perimeter panel (1) of the prismatic main structure, while the diode is inserted into a hole (21) located in the center of the front plate (19) of the mount.

With the modular interferometry equipment of the first modality, a Michelson-type interferometer is assembled, which, once assembled, comprises a prismatic main structure formed by coupling the perimeter panels (1, 2, 3, and 4), the base panel (5), and the top panel (6). Thanks to the rectangular cutouts on the perimeter edges of these panels (1, 2, 3, 4, 5, 6), the panels are joined using finger or comb-type joints. This results in easy assembly of the prismatic structure, as well as easy and quick alignment of the interferometer.

The base (5) of the main structure includes four holes (7) located at each corner, where suction cup-type mounts are attached to later secure the prototype to a workbench (not shown). The beam splitter with its rectangular frame (8) is mounted on the bottom panel (5) of the rectangular prismatic structure in the cross-shaped central slot (9).

The interferometer includes a divergent laser light source that defines an interference pattern composed of fringes of equal inclination (bright and dark concentric rings). In the illustrated embodiment, the interference pattern exits through the circular output opening (28) located at the center of the fourth perimeter panel (4).

An important factor for the superposition of the two projected light beams to observe the interference pattern on the screen is the tilt of the mirrors (16), by means of simple mechanisms fixed to the second and third perimeter panels (2, 3), which are perpendicular to each other, of the rectangular prismatic main structure, through holes (11) in each of these panels. These mechanisms consist of three butterfly nuts (12), positioned on the external part of the prismatic main structure, where they are screwed in with bolts (13) whose heads are located inside the prismatic structure and clamp—together with the butterfly nut—one of the perimeter panels of the prismatic main structure; three helical springs (14), which are traversed by the bolts (13); and a rectangular mirror holder (15) that clamps the springs against the corresponding perimeter panel of the prismatic main structure, wherein the mirror holder (15) includes a mirror (16) on its inner face.

The light emission source consists of a laser light diode powered by a 5-volt supply through a micro-USB module aligned with the connection hole (17) of the first perimeter panel, for its power supply. The diode is inserted into a mount, which is defined by a compartment composed of five square plates (18, 19)—perimeter plates (18) and a front plate (19) with a central hole (21)—with their respective rectangular cutouts on their perimeter edges, forming an interlocking arrangement for assembling the mount, wherein it should be noted that these plates are inserted into the slots (20) of the first perimeter panel (1) of the prismatic main structure, while the diode is inserted into a hole (21) located in the center of the front plate of the mount.

In a second modality of the modular interferometry equipment for teaching, it is designed to assemble a Mach-Zehnder-type interferometer, whose optical elements are mounted on the faces that make up a rectangular prismatic structure.

In this second modality of the modular equipment, for assembling a Mach-Zehnder-type interferometer, the panels also feature a series of rectangular cutouts along their perimeter edges so that the assembly is done using finger or comb-type joints. This results in easy assembly of the prismatic structure and the optical elements, as well as easy and quick alignment of the interferometer.

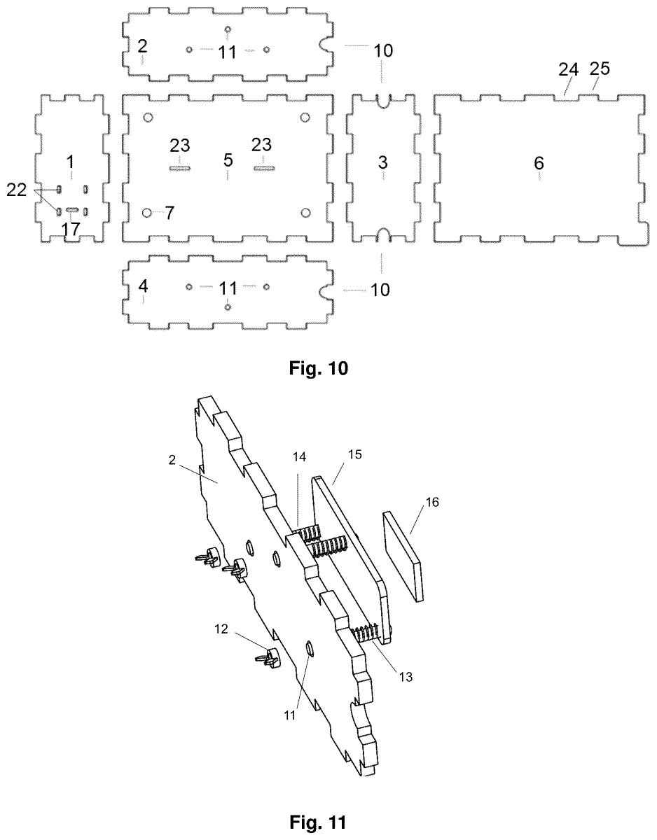

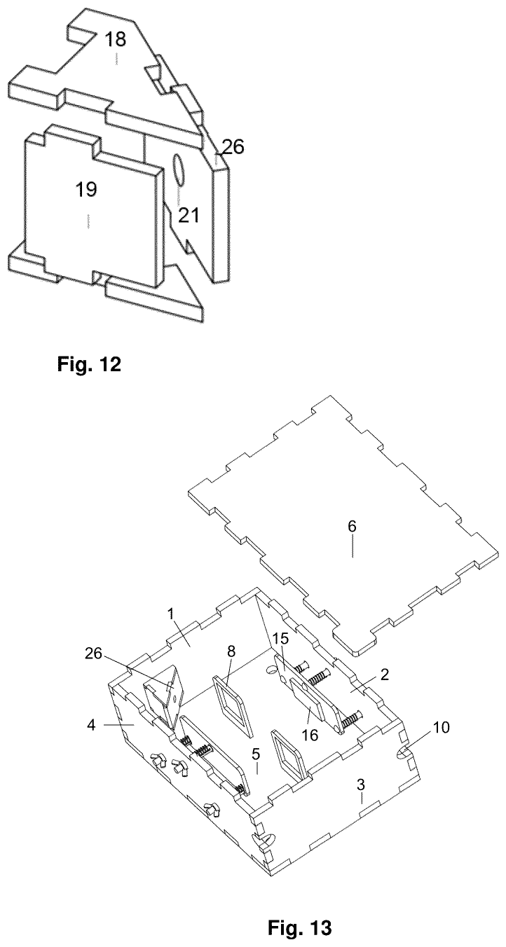

In this second modality, as illustrated in FIG. 10, the rectangular base (5) of the main structure includes four holes (7), one in each corner, to place suction cup-type holders, which serve to hold the prototype on some type of surface or workbench, and with longitudinal slots (23) aligned collinearly.

The first rectangular perimeter panel (1) includes assembly slots (22), not in its central part as in the first modality, but near one of its lateral edges, to attach a triangular mount, and a connection hole (17) adjacent to the assembly slots (22) to insert the connection to the light emission source; a second rectangular perimeter panel (2) with holes (11), which will receive bolts (13) from one of the tilt adjustment mechanisms; said second perimeter panel (2) includes an elliptical cutout (10) in the central part of its lateral edge that lies adjacent to a third rectangular perimeter panel (3); a third rectangular perimeter panel (3) with an elliptical cutout (10) in the central part of each of its lateral edges; a fourth rectangular perimeter panel (4) with holes (11), which will receive bolts (13) from the other tilt adjustment mechanism; said fourth perimeter panel (4) includes an elliptical cutout (10) in the central part of its lateral edge that lies adjacent to the third rectangular perimeter panel (3).

Wherein the first and third perimeter panels (1 and 3) are shorter in length than the second and fourth perimeter panels (2 and 4).

A rectangular top panel (6), which defines the top cover of the main structure once the interferometer is assembled.

All these panels have rectangular assembly cutouts on their perimeter edges, defining a plurality of notches (24) and tabs (25), arranged alternately for interlocking assembly, with the tabs (25) of one panel being inserted into the notches (24) of another adjacent panel, to form a prismatic main structure.

In this second modality, the equipment includes two beam splitters (8), which are partially reflective mirrors mounted on independent rectangular frames. In this way, for the assembly of the Mach-Zehnder interferometer, each beam splitter (8) is mounted on the bottom base (5) of the rectangular prismatic structure in the longitudinal slots (23), with the splitters (8) aligned collinearly along the base (5) of the main structure.

A divergent laser is used as the light source. In this type of interferometer, it is possible to quickly obtain interference patterns composed of fringes of equal thickness (straight or semi-straight fringes), which appear as alternating bright and dark fringes. The interference pattern exits through two lateral output openings defined by the union of the elliptical cutouts (10) at the corners formed by the junction of the third perimeter panel (3) with the second and fourth perimeter panels (2 and 4).

To obtain an interference pattern, the two light beams traveling along different paths must be superimposed. This is achieved by tilting one or both mirrors (16) using tilt adjustment mechanisms (15) fixed to the second and fourth perimeter panels (2, 4). The mechanism moves because there are three holes (11) in the second and fourth perimeter panels (2 and 4) through which bolts (13) are inserted, and these are adjusted by compression of helical springs (14) and butterfly nuts (12).

In this second modality of the equipment, two tilt adjustment mechanisms are also included. Each consists of three butterfly nuts (12), which, when the interferometer is assembled, are positioned on the external part of the prismatic main structure, where they are screwed in using bolts (13) whose heads are located inside the prismatic structure and clamp—together with the butterfly nut—one of the perimeter panels (2 and 4) of the prismatic main structure; three helical springs (14), which, when assembling the interferometer, are clamped between one of the perimeter panels (2 and 4) of the prismatic main structure and a rectangular mirror holder (15), said springs (14) being traversed longitudinally by the bolts (13); and where the mirror holder (15) includes a mirror (16).

A laser light diode is used as the light source. This diode is powered by a 5-volt supply through a micro-USB module aligned with the connection hole (17) for its power supply. The diode is inserted into a triangular mount, which is a compartment in the shape of a triangular prism, assembled from a square plate (19), a base plate and a triangular top plate (18), and a diagonal plate (26) with a central hole (21). All these plates (18, 19, and 26) are coupled together using their respective rectangular cutouts along the perimeter, forming an interlocking arrangement for assembling the mount, wherein it should be noted that these plates (18 and 19) are inserted into the slots (22) of the first perimeter panel (1) of the prismatic main structure when assembling the interferometer, while the diode is inserted into a hole (21) located in the center of the diagonal plate (26) of the mount.

With this second modality of the equipment, the main characteristics for assembling a Mach-Zehnder-type interferometer are provided, in which the optical elements are placed on the faces that make up a rectangular prismatic structure. The main feature of the structure is that along the perimeter of each of the perimeter panels (1, 2, 3, and 4), the base (5), and the top (6), a series of rectangular cutouts are made so that assembly is carried out using finger or comb-type joints. This results in easy assembly of the prismatic structure and the optical elements, as well as easy and quick alignment of the interferometer.

With the modular interferometry kit of the second modality, a Mach-Zehnder type interferometer is assembled. Once assembled, it comprises a prismatic main structure formed by the coupling of the perimeter panels (1, 2, 3, and 4), the base panel (5), and the top panel (6). Thanks to the rectangular notches along the edges of these panels, they are joined together using finger or comb-type joints. This results in an easy assembly of the prismatic structure as well as a simple and quick alignment of the interferometer.

The base (5) of the main structure features four holes (7), one in each corner, for inserting suction cups, which serve as fasteners to hold the prototype onto a surface or workbench. Two beam splitters, composed of partially reflective mirrors mounted on independent rectangular frames (8), are mounted onto the lower base (5) of the prismatic rectangular structure using the longitudinal slots (23), remaining aligned along the main structure.

The Mach-Zehnder interferometer assembled with the second modality of the kit includes a divergent laser as the light source. In this type of interferometer, it is possible to quickly obtain interference patterns composed of fringes of equal thickness (straight or slightly curved fringes), which appear as alternating bright and dark fringes. The interference pattern exits through two output holes located on the face (4) opposite the light source; both cutouts are elliptical (10) in shape.

To observe an interference pattern, the two light beams traveling along different paths must be superimposed. This is achieved by tilting one or both mirrors (16) using tilt adjustment mechanisms (15) mounted on two of the perimeter panels (2 and 4). The mechanism operates because there are three holes (11) on the side panels through which bolts (13) are inserted and adjusted via compression of springs (14) and butterfly nuts (12).

The light-emitting source consists of a laser diode powered by a 5-volt supply through a micro-USB module whose power connection hole (17) is located on the first perimeter panel (1) of the prismatic structure. The diode is inserted into a triangular mount made up of a triangular prism-shaped compartment, defined by a square plate (19), a triangular base plate, a triangular top plate (18), and a diagonal plate (26) with a central hole (21). All these plates (18, 19, and 26) are assembled using their respective rectangular cutouts along the perimeter, forming an interlocking arrangement for the mount. It is worth noting that these plates (18 and 19) are inserted into the slots (22) of the first perimeter panel (1) of the prismatic main structure during assembly, while the diode is inserted into a hole (21) located in the center of the diagonal plate (26) of the mount.

The technical advantages offered by the modular interferometry kit for teaching purposes include an intuitive and easy assembly or disassembly of the rectangular prism; quick and simple system alignment; the size of the interference pattern formed by equal-inclination fringes increases as the distance between the interferometer and the observation screen increases; the materials for constructing the prism can vary depending on the user's needs; and the instrument can be used in wave physics education as a practical complement to theoretical lessons.

1. A modular apparatus for teaching interferometry, characterized in that it comprises a plurality of panels assembled together to form a main structure, comprising:
a base panel (5) having four holes (7) arranged at each corner of the main structure, and a central diagonal slot (9) along with two longitudinal slots (23), wherein the central slot (9) is positioned between the two longitudinal slots (23) for the placement of at least one beam splitter (8);
a first rectangular perimeter panel (1) comprising a plurality of central slots (20) and a connection hole (17) adjacent to the central slots (20), and lateral mounting slots (22) located near one of its side edges, and another connection hole (17) adjacent to the lateral mounting slots (22); said central slots (20) and lateral slots (22) are configured to receive a mount in the required position, either centrally or laterally on the first panel (1), wherein the mount has a hole for placing a light-emitting source directed toward the beam splitter;
a second rectangular perimeter panel (2) comprising a plurality of fixation holes (11); said second perimeter panel (2) includes an elliptical cutout (10) at the central portion of its lateral edge that is adjacent to a third rectangular perimeter panel (3); the third rectangular perimeter panel (3) includes a plurality of fixation holes (11);
said third rectangular perimeter panel (3) includes an elliptical cutout (10) at the central portion of each of its lateral edges for the output of the interference pattern;
a fourth perimeter panel (4) comprising a central hole (28) for the output of the interference pattern and a plurality of fixation holes (11); said fourth perimeter panel (4) includes an elliptical cutout (10) at the central portion of its lateral edge that is adjacent to the third rectangular perimeter panel (3); and
a rectangular top panel (6), which defines the top cover of the main structure once the interferometer is assembled;
wherein the fixation holes (11) of the perimeter panels are arranged longitudinally and spaced equidistantly, with at least one above the lateral sides, which accommodate inclination adjustment mechanisms for a light-reflecting medium, preferably a mirror (16).

2. The modular equipment for teaching interferometry according to claim 1, wherein the inclination adjustment mechanisms includes three butterfly nuts (12), which, once the interferometer is assembled, are positioned on the external part of the prismatic main structure, said nuts being threaded onto screws (13), the heads of which are placed inside the prismatic structure and, together with the butterfly nuts, press one of the perimeter panels of the prismatic main structure; three helical springs (14), which, when the interferometer is assembled, are compressed between one of the perimeter panels of the prismatic main structure and a rectangular mirror holder (15), said springs (14) being longitudinally traversed by the screws (13); and wherein the mirror holder (15) includes a mirror (16).

3. The modular equipment for teaching interferometry according to claim 1, wherein if a Michelson-type interferometer is to be assembled, the inclination adjustment mechanisms are mounted on two adjacent perimeter walls, and in the case of assembling a Mach-Zehnder-type interferometer, the adjustment mechanisms are mounted on two opposite perimeter walls.

4. The modular equipment for teaching interferometry according to claim 1, further including a first mountable holder in the shape of a square prism, comprising five square plates (18, 19) that can be assembled with each other—four perimeter plates (18) and one front plate (19)—each with rectangular cutouts along the perimeter to form a coupling arrangement for assembling the holder; and a second mountable holder in the shape of a triangular prism, comprising a square plate (19), a triangular base plate and a triangular top cover plate (18), and a diagonal plate (26) with a central hole (21), all of these plates (18, 19, and 26) being assembled together via respective rectangular cutouts along their perimeter to form a coupling arrangement for assembling the second holder.

5. The modular equipment for teaching interferometry according to claim 1, wherein the assembly of the panels of the main structure is by means of finger-type or comb-type joints.

6. The modular equipment for teaching interferometry according to claim 1, c wherein suction cups are placed in the holes (7) of the base (5) to fix the interferometer to a surface.

7. The modular equipment for teaching interferometry according to claim 1, wherein the light-emitting source includes a laser diode powered by a 5-volt supply through a micro USB module aligned with a connection hole (17) located in the first perimeter panel (1) of the main structure.

8. The modular equipment for teaching interferometry according to claim 1, wherein the light-emitting source is inserted into a holder made up of five square plates (18, 19) with rectangular cutouts along their perimeter, forming a coupling arrangement for assembling the holder.

9. A Michelson-type interferometer formed from the modular interferometry equipment of claim 1, further comprising a plurality of panels assembled with each other to form a main structure, which includes a base panel (5) having four holes (7) located at each corner of the main structure, and in its central part a central slot (9) in diagonal form and two longitudinal slots (23), the central slot (9) being in the shape of a cross to accommodate a beam splitter (8);
the first rectangular perimeter panel (1) includes a plurality of central slots (20) and a connection hole (17); said central slots (20) and said assembly slot (22) are intended to couple a mount in the required position, either in the central or lateral part of the first panel (1), wherein the mount has a hole to accommodate a light-emitting source directed toward the beam splitter;
a second rectangular perimeter panel (2) with a plurality of fastening holes (11);
a third rectangular perimeter panel (3) including a plurality of fastening holes (11);
a fourth perimeter panel (4) with a central hole (28) for output of the interference pattern; and
a rectangular top panel (6), which defines the upper cover of the main structure once the interferometer is assembled;
wherein the fastening holes (11) of the perimeter panels are arranged longitudinally and equidistantly spaced, with at least one hole positioned above the sides, to accommodate inclination adjustment mechanisms for a light-reflecting element, preferably a mirror (16).

10. A Mach-Zehnder-type interferometer formed from the modular interferometry equipment of claim 1, further comprising a plurality of panels assembled with each other to form a main structure, which includes a base panel (5) having four holes (7) located at each corner of the main structure, and in its central part two longitudinal slots (23) for placing a beam splitter (8) in each slot;
the first rectangular perimeter panel (1) includes a plurality of lateral assembly slots (22) arranged near one of its lateral edges, and a connection hole (17) adjacent to the assembly slots (22); said assembly slots (22) serve to couple a mount on the lateral side of the first panel (1), wherein the mount has a hole to accommodate a light-emitting source directed toward the beam splitter;
a second rectangular perimeter panel (2) with a plurality of fastening holes (11); said second perimeter panel (2) includes an elliptical cut-out (10) in the central part of its lateral edge, which is adjacent to a third rectangular perimeter panel (3);
the third rectangular perimeter panel (3) includes an elliptical cut-out (10) in the central part of each of its lateral edges for output of the interference pattern;
a fourth perimeter panel (4) having a plurality of fastening holes (11); said fourth perimeter panel (4) includes an elliptical cut-out (10) in the central part of its lateral edge, which is adjacent to the third rectangular perimeter panel (3); and
a rectangular top panel (6), which defines the upper cover of the main structure once the interferometer is assembled;
wherein the fastening holes (11) of the perimeter panels are arranged longitudinally and spaced equidistantly, with at least one hole located above the sides, which accommodate inclination adjustment mechanisms for a light-reflecting element, preferably a mirror (16).

11. The Mach-Zehnder-type interferometer according claim 1, wherein the light-emitting source is introduced into a triangular mount formed by a triangular prism-shaped compartment, defined by a square plate (19), a triangular base plate, a triangular top plate (18), and a diagonal plate (20) with a central hole (21), all of said plates (18, 19, and 20) being coupled together through their respective rectangular notches along the perimeter, forming an assembly arrangement for mounting the mount.
